(19) United States
(12) Patent Application Publication
(10) Pub. No.: US 2024/0105903 A1
(43) Pub. Date: Mar. 28, 2024

(54) PRODUCTION DEVICE OF ELECTRODE MEMBER AND PRODUCTION METHOD OF ELECTRODE MEMBER

(71) Applicant: TOYOTA JIDOSHA KABUSHIKI KAISHA, Toyota-shi Aichi-ken (JP)

(72) Inventors: Katsushi ENOKIHARA, Toyota-shi (JP); Noriyuki Kato, Nagoya-shi Aichi-ken (JP); Kiminori Unno, Hamamatsu-shi Shizuoka-ken (JP); Kenji Koura, Toyota-shi Aichi-ken (JP); Takeshi Kondo, Kariy-shi Aichi-ken (JP)

(73) Assignee: TOYOTA JIDOSHA KABUSHIKI KAISHA, Toyota-shi Aichi-ken (JP)

(21) Appl. No.: 18/369,864

(22) Filed: Sep. 19, 2023

(30) Foreign Application Priority Data
Sep. 26, 2022 (JP) 2022-152577

(51) Int. Cl. H01M 4/04; H01M 4/36

(52) U.S. Cl. CPC H01M 4/0404; H01M 4/366

(57) ABSTRACT

A production device of an electrode member to be used for a battery, the production device including: a backup roll configured to support a current collector to be carried; a first die configured to form a first coating layer by coating the current collector on the backup roll with a first slurry; and a second die configured to form a second coating layer by coating the first coating layer on the backup roll with a second slurry, wherein each of the first die and the second die are independent; and when horizontal direction is regarded as a reference 0°, perpendicular downward is regarded as +90°, and perpendicular upward is regarded as −90°, a discharge angle of the second slurry in the second die is −90° or more and +60° or less.

### CROSS-REFERENCE TO RELATED APPLICATIONS

This application is based upon and claims the benefit of priority of the prior Japanese Patent Application No. 2022-152577, filed on Sep. 26, 2022, the entire contents of which are incorporated herein by reference.

### TECHNICAL FIELD

The present disclosure relates to a production device of an electrode member, and a production method of the electrode member.

### BACKGROUND ART

A battery such as a lithium ion secondary battery is provided with an electrode body including a current collector, and an electrode layer containing an active material. As a manufacturing method of an electrode body, for example, a method wherein an electrode member is manufactured by pasting a slurry on a current collector to form a coating layer, and then drying the electrode member to form an electrode layer from the coating layer, has been known. Also, a production device for manufacturing such an electrode member has been known.

For example, Patent Literature 1 discloses a coating device including a coating head configured to coat a web that runs at a fixed running speed, with n kinds of a coating liquid. In Patent Literature 1, an object is to provide a coating device capable of intermittent coating and coating different kinds of coating parts. Also, Patent Literature 2 discloses a production method of an electrode including a step of pasting an electrode paste on a current collecting foil by a die, and a step of drying the electrode paste pasted. Also, Patent Literature 3 discloses a coating device including a backup roll that carries a base material, and a die that ejects a paste (slurry).

### CITATION LIST

### Patent Literatures

Patent Literature 1: Japanese Patent Application Laid-Open (JP-A) No. 2016-147216
Patent Literature 2: JP-A No. 2022-080610
Patent Literature 3: JP-A No. 2016-064339

### SUMMARY OF DISCLOSURE

### Technical Problem

For example, in Patent Literature 1, a plurality of coating liquid (slurry) is applied using one die. In this case, since the plurality of slurry always contact each other, there is a possibility that the slurry in each layer may be muddled. Then, the inventors of the present disclosure have studied about applying each slurry using a plurality of dies that are each independent, and obtained a knowledge as follows.

That was, the inventors obtained a knowledge that the slurry may drop off from a lip of the die because of its own weight depending on discharge angle of the slurry in the die, and thereby a production failure occurred.

The present disclosure has been made in view of the above circumstances, and a main object thereof is to provide a production device of an electrode member capable of inhibiting occurrence of production failure.

### Solution to Problem

[1]

A production device of an electrode member to be used for a battery, the production device including: a backup roll configured to support a current collector to be carried; a first die configured to form a first coating layer by coating the current collector on the backup roll with a first slurry; and a second die configured to form a second coating layer by coating the first coating layer on the backup roll with a second slurry, wherein each of the first die and the second die are independent; and when horizontal direction is regarded as a reference 0°, perpendicular downward is regarded as +90°, and perpendicular upward is regarded as −90°, a discharge angle of the second slurry in the second die is −90° or more and +60° or less.

[2]

The production device of an electrode member according to [1], wherein a discharge angle of the first slurry in the first die is −90° or more and +30° or less.

[3]

The production device of an electrode member according to [1] or [2], wherein the second slurry contains an active material and a binder; a shear viscosity of the second slurry in a shear velocity of 1 s⁻¹ is 5 Pa·second or less; and a thickness of the second coating layer is 200 μm or more.

[4]

The production device of an electrode member according to any one of [1] to [3], wherein, in a carrying direction of the current collector, the production device includes: a first sensor configured to measure a state of a surface of the first coating layer, in a downstream side of the first die and in an upstream side of the second die; and a second sensor configured to measure a state of a surface of the second coating layer, in a downstream side of the second die.

[5]

A production method of an electrode member to be used for a battery, the production method comprising: a supporting step of supporting a current collector to be carried, by a backup roll; a first coating layer forming step of forming a first coating layer by coating the current collector on the backup roll with a first slurry using a first die; and a second coating layer forming step of forming a second coating layer by coating the first coating layer on the backup roll with a second slurry using a second die; wherein each of the first die and the second die are independent; and when horizontal direction is regarded as a reference 0°, perpendicular downward is regarded as +90°, and perpendicular upward is regarded as −90°, a discharge angle of the second slurry in the second die is −90° or more and +60° or less.

Effects of Disclosure

The production device of an electrode member in the present disclosure exhibits an effect of inhibiting occurrence of production failure.

### BRIEF DESCRIPTION OF DRAWINGS

FIG. 1A is a schematic perspective view exemplifying the production device of an electrode member in the present disclosure.

FIG. 1B is a cross-sectional view exemplifying the production device of an electrode member in the present disclosure.

FIG. 2 is a schematic cross-sectional view exemplifying the production method of an electrode member in the present disclosure.

FIG. 3A is a schematic cross-sectional view explaining the problem in the present disclosure.

FIG. 3B is another schematic cross-sectional view explaining the problem in the present disclosure.

FIG. 4A is a schematic cross-sectional view exemplifying the production device of an electrode member in the present disclosure.

FIG. 4B is another schematic cross-sectional view exemplifying the production device of an electrode member in the present disclosure.

FIG. 5A is a graph illustrating the results of Example 1.

FIG. 5B is the results of Comparative Example 1.

FIG. 6 is a graph illustrating the results of Examples 1 to 4 and Comparative Example 1.

### DESCRIPTION OF EMBODIMENTS

The embodiments in the present disclosure will be hereinafter explained in details with reference to drawings. Each drawing described as below is a schematic view, and the size and the shape of each portion are appropriately exaggerated in order to be understood easily. Furthermore, in the present description, upon expressing an embodiment of arranging one member with respect to the other member, when it is expressed simply □on□ or □below□, both of when the other member is directly arranged on or below the one member so as to contact with each other, and when the other member is arranged above or below the one member interposing an additional member, can be included unless otherwise described.

A. Production Device of Electrode Member

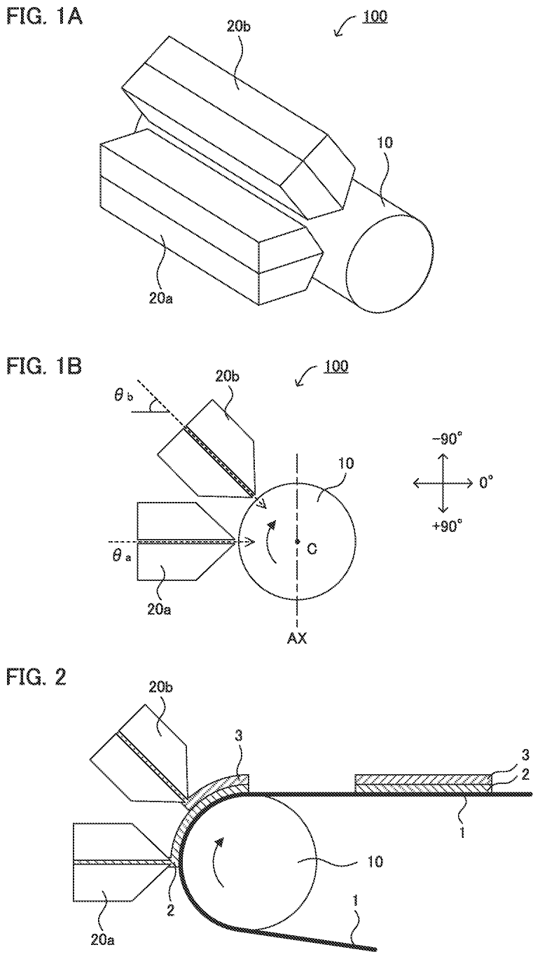

FIG. 1A is a schematic perspective view exemplifying the production device of an electrode member in the present disclosure, and FIG. 1B is a schematic cross-sectional view exemplifying the production device of an electrode member in the present disclosure. Also, FIG. 2 is a schematic cross-sectional view exemplifying the production method of an electrode member in the present disclosure. As shown in FIG. 1A and FIG. 1B, production device 100 includes backup roll 10, first die 20a, and second die 20b.

As shown in FIGS. 1A, 1B, and 2, the backup roll 10 is a member configured to support current collector 1 to be carried. The first die 20a is a member configured to form first coating layer 2 by coating the current collector 1 on the backup roll 10 with a first slurry. The second die 20b is a member configured to form second coating layer 3 by coating the first coating layer 2 on the backup roll 10 with a second slurry.

As shown in FIG. 1B, each of the first die 20a and the second die 20b are independent. Also, as shown in FIG. 1B, when horizontal direction is regarded as a reference 0°, perpendicular downward is regarded as +90°, and perpendicular upward is regarded as −90°, a discharge angle θ_{b} of the second slurry in the second die 20b is −90° or more and +60° or less. In FIG. 1B, the discharge angle θ_{b} of the second slurry in the second die 20b is +60°, and a discharge angle θₐ of the first slurry in the first die 20a is 0°.

According to the present disclosure, since the discharge angle of the second slurry in the second die is in the specified angle, occurrence of production failure can be inhibited. As described above, for example, in Patent Literature 1, a plurality of coating liquid (slurry) is applied using one die. In this case, since the plurality of slurry always contact each other, there is a possibility that the slurry in each layer may be muddled. In particular, in the edge parts (starting edge and end edge) where rapid fluctuation occurs, the muddle of slurry is remarkable. Further, since a plurality of coating layers are formed using a plurality of slurry, for example, it is difficult to accurately understand the thickness of each coating layers.

Then, the inventors of the present disclosure have studied about applying each slurry using each independent plurality of dies. By using the plurality of dies, the muddle of the slurry in each layer can be inhibited. Further, by arranging a detector between each die, the thickness of each coating layers can be accurately known.

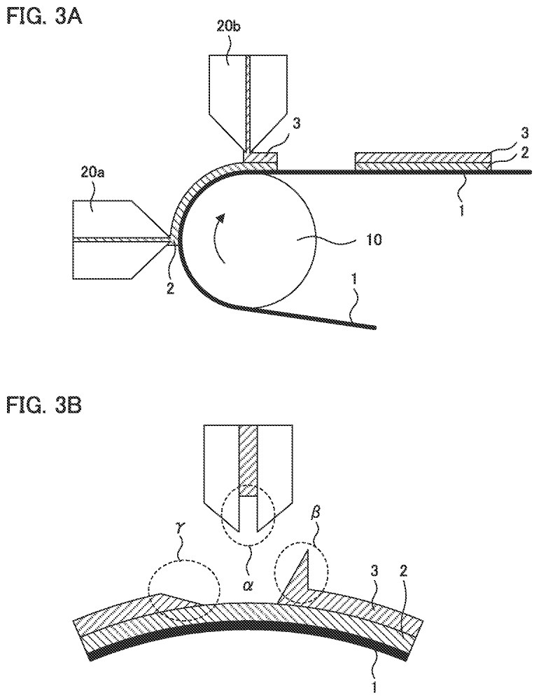

On the other hand, when each independent plurality of dies are used, in the carrying direction of a current collector, it has been found out that coating failure occurred in the second die arranged in downstream side on the basis of the first die. In specific, as shown in FIG. 3A, when the discharge angle of the slurry in the second die 20b is large, as shown in FIG. 3B, it has been found out that the second slurry may drop off from the lip of the second die 20b because of its own weight. In FIG. 3B, the second slurry present in the lip (region a) of the second die 20b drops off because of its own weight, and is taken in to the end edge (region of the second coating layer 3; thereby, a protruding part is generated. On the other hand, in the next starting edge (region y) of the second coating layer 3, the second slurry is not applied, and thus, there is a defective part.

In this manner, the inventors of the present disclosure have obtained a knowledge that, depending on the discharge angle of the slurry in the die, the slurry may drop off from the lip of the die because of its own weight to cause production failure. To this, in the present disclosure, the discharge angle of the second slurry in the second die is set to the specified angle to inhibit the occurrence of the production failure.

Also, on the occasion of forming the electrode layer by drying the coating layer, binder concentration in the thickness direction may be uneven along with the evaporation of a dispersion medium. In specific, in the electrode layer, the binder concentration may be low in the current collector side, and the binder concentration may be high in the opposite side to the current collector. To this, as described later, the binder concentration in the first slurry to be applied by a die (first die) in the upstream side is set comparatively high, and the binder concentration in the second slurry to be applied by a die (second die) in the downstream side is set comparatively low, and thus, the binder concentration in the electrode layer in the thickness direction can be even.

1. Die

The production device of an electrode member in the present disclosure includes at least two dies as the dies for applying slurry. In some embodiments, the die (die head) is a slit die including a slit that extends to an orthogonal direction to a carrying direction of the current collector. The slurry is applied via the slit.

The first die is a die configured to form a first coating layer by coating the current collector on the backup roll with a first slurry. The first die may be a die configured to directly coat the current collector with the first slurry, and may be a die configured to coat the current collector with the first slurry interposing an additional layer. Examples of the additional layer may include a coating layer.

The second die is a die configured to form a second coating layer by coating the first coating layer on the backup roll with a second slurry. The second die is usually arranged in the downstream side on the basis of the first die in the carrying direction of the current collector. The second die may be a die configured to directly coat the first coating layer with the second slurry, and may be a die configured to coat the first coating layer with the second slurry interposing an additional layer. Examples of the additional layer may include a coating layer. In some embodiments, the first die and the second die are arranged so as to neighbor to each other in the carrying direction of the current collector.

Each of the first die and the second die are independent. In other words, neither the first die nor the second die corresponds to the one that ejects a plurality of slurry by one die (die head) at the same time (such as die 100 in FIG. 1 of Patent Literature 1).

As shown in FIG. 1B, horizontal direction is regarded as a reference 0°, perpendicular downward is regarded as +90°, and perpendicular upward is regarded as −90°, and a discharge angle of the second slurry in the second die 20b is regarded as θ_{b}. The discharge angle θ_{b} is usually +60° or less. The discharge angle θ_{b} may be +45° or less, may be +30° or less, and may be 0°. Meanwhile, the discharge angle θ_{b} is usually −90° or more, and may be −85° or more. Also, the discharge angle θ_{b} may be larger than 0° and +60° or less. In this case, the discharge angle θ_{b} may be 5° or more. Meanwhile, the discharge angle θ_{b} may be −90° or more and smaller than 0°. In this case, the discharge angle θ_{b} may be −5° or less.

As shown in FIG. 1B, the discharge angle of the first slurry in the first die 20a is regarded as ea. The discharge angle θₐ is not particularly limited, and for example, it is +60° or less, may be +45° or less, may be +30° or less, and may be 0°. Meanwhile, the discharge angle θₐ is usually −90° or more, and may be −85° or more. Also, the discharge angle θₐ may be larger than 0° and +60° or less. In this case, the discharge angle θₐ may be 5° or more. Meanwhile, the discharge angle θₐ may be −90° or more and smaller than 0°. In this case, the discharge angle θₐ may be −5° or less.

As shown in FIG. 1B, an axis going through a rotating center C of the backup roll 10 and is parallel to a perpendicular direction is regarded as AX. In FIG. 1B, the first die 20a and the second die 20b are arranged in the same region (left side region from the axis AX in FIG. 1B) among two regions divided by the axis AX. In this case, the discharge angle θ_{b} is larger than discharge angle θₐ. The difference between the discharge angle θ_{b} and the discharge angle θₐ is, for example, 5° or more, may be 15° or more, and may be 30° or more. Meanwhile, although not illustrated in particular, the first die 20a and the second die 20b may be respectively arranged in different regions among the two regions divided by the axis AX.

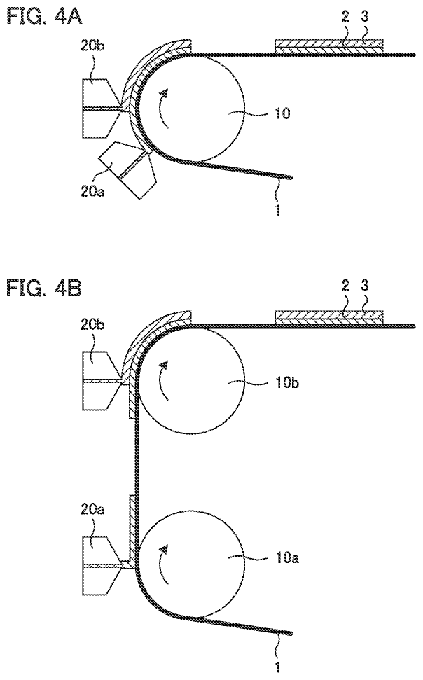

As shown in FIG. 4A, the discharge angle θ_{b} in the second die 20b may be 0°, and the discharge angle θₐ in the first die 20a may be less than 0°. Also, as shown in FIG. 4B, the production device of an electrode member may include first backup roll 10a and second backup roll 10b. The first die 20a may apply the first slurry to the current collector 1 on the first backup roll 10a, and the second die 20b may apply the second slurry to the first coating layer 2 on the second backup roll 10b.

The first die is a die configured to apply the first slurry, and the second die is a die configured to apply the second slurry. The slurry (first slurry and second slurry) contains at least an active material and a dispersion medium, and may further contain at least one of a binder and a conductive material.

The shear viscosity of the second slurry in a shear velocity of 1/s is, for example, 5 Pa·second or less, may be 4 Pa·second or less, may be 3 Pa·second or less, and may be 2 Pa·second or less. Also, the proportion of the binder in the solid content of the second slurry is, for example, 5 weight % or less, and may be 3 weight % or less. Incidentally, when the solid content of the second slurry contains a plurality of binders, the proportion of the binder corresponds to the total of the plurality of the binders.

In some embodiments, the proportion (weight %) of the binder in the solid content of the first slurry is more than the proportion (weight %) of the binder in the solid content of the second slurry. The proportion (weight %) of the binder in the solid content of the first slurry is regarded as C₁□, and the proportion (weight %) of the binder in the solid content of the second slurry is regarded as C₂□. The rate of C₁□ with respect to C₂□, which is C₁□/C₂□ is, for example, 3 or more, and may be 5 or more. Meanwhile, the C₁□/C₂□ is, for example, 10 or less.

2. Backup Roll

The backup roll in the present disclosure is a member configured to support the current collector to be carried. The current collector is usually carried in the state a specified tensile is applied thereto. Also, the backup roll carries the current collector by wrapping the current collector around itself. Also, the backup roll is typically a member in a columnar shape or a cylindrical shape. The backup roll is configured to rotate around a rotation axis.

3. Production Device of Electrode Member

In some embodiments, the production device of an electrode member in the present disclosure includes, in a carrying direction of the current collector, a first sensor configured to measure a state of a surface of the first coating layer, in a downstream side of the first die and in an upstream side of the second die. Examples of the first sensor may include, a displacement sensor and a color sensor. For example, by arranging the displacement sensor, the thickness of the first coating layer can be accurately known. Examples of the displacement sensor may include a laser displacement sensor. Also, by using the color sensor, a region where the first coating layer is formed, and a region where the first coating layer is not formed (region where the current collector is exposed) can be accurately known.

The production device of an electrode member in the present disclosure may include, in a carrying direction of the current collector, a second sensor configured to measure a state of a surface of the second coating layer, in a downstream side of the second die. Examples of the second sensor may include, a displacement sensor and a color sensor.

4. Electrode Member

The electrode member in the present disclosure includes a current collector, and a coating layer arranged on the current collector. The coating layer includes layers in the order of a first coating layer and a second coating layer from the current collector side.

Examples of the material for the current collector may include a metal material such as aluminum, copper, SUS, and nickel. Examples of the shape of the current collector may include a foil shape.

There are not particular limitations on the relation between the thickness (T₁) of the first coating layer and the thickness (T₂) of the second coating layer. The thickness of the both may be the same and may be different. □The thickness of the first coating layer and the thickness of the second coating layer being same□ means that the difference in the thickness of the both is 10 μm or less.

Also, the thickness T₂ of the second coating layer may be larger than the thickness T₁ of the first coating layer. In this case, the rate of T₂ with respect to T₁, which is T₂/T₁ is larger than 1, may be 1.5 or more, and may be 2 or more. Meanwhile, the T₂/T₁ is, for example, 10 or less, and may be 5 or less.

Also, the thickness T₂ of the second coating layer may be smaller than the thickness T₁ of the first coating layer. In this case, the rate of T₂ with respect to T₁, which is T₂/T₁ is smaller than 1, may be 0.9 or less, and may be 0.5 or less. Meanwhile, the T₂/T₁ is, for example, 0.1 or more.

The coating layer in the present disclosure includes at least a first coating layer and a second coating layer. The coating layer in the present disclosure may include just the first coating layer and the second coating layer. On the other hand, the coating layer in the present disclosure may include an additional coating layer in addition to the first coating layer and the second coating layer. The additional coating layer may be a single layer, and may be a plurality of layers.

The thickness T₁ of the first coating layer is, for example, 50 μm or more and 500 μm or less. The thickness T₂ of the second coating layer is, for example, 50 μm or more and 500 μm or less. Above all, the thickness T₂ of the second coating layer may be 200 μm or more, may be 250 μm or more, may be 300 μm or more, and may be 350 μm or more. Also, the thickness of the coating layer is, for example, 200 μm or more, may be 400 μm or more, and may be 600 μm or more. Meanwhile, the thickness of coating layer is, for example, 1000 μm or less.

Each of the first coating layer and the second coating layer may contain a binder. In that case, there are no limitations on the relation between the proportion (weight %) of the binder in the first coating layer and the proportion (weight %) of the binder in the second coating layer. The proportion of the both may be the same and may be different. □The proportion (weight %) of the binder in the first coating layer and the proportion (weight %) of the binder in the second coating layer being the same□means that the difference of the proportion between the both is 1 weight % or less.

The proportion (weight %) of the binder in the first coating layer is regarded as C₁, and the proportion (weight %) of the binder in the second coating layer is regarded as C₂. When C₁>C₂, the rate of C₂ with respect to C₂, which is C₁/C₂ is, for example, 3 or more, and may be 5 or more. Meanwhile, the C₁/C₂ is, for example, 10 or less. Also, when C₁>C₂, there are no particular limitations on the relation of the above described thickness, and it may be T₂>T₁, may be T₂=T₁, and may be T₂<T₁.

When C₁<C₂, the rate of C₁ with respect to C₂, which is C₁/C₂ is, for example, 0.9 or less, and may be 0.8 or less. Meanwhile, the C₁/C₂ is, for example, 0.1 or more. Also, when C₁<C₂, there are no particular limitations on the relation of the above described thickness, and it may be T₂>T₁, may be T₂=T₁, and may be T₂<T₁. Incidentally, also when C₁=C₂, there are no particular limitations on the relation of the above described thickness, and it may be T₂>T₁, may be T₂=T₁, and may be T₂<T₁.

Each of the first coating layer and the second coating layer contains at least an active material. The first coating layer and the second coating layer may contain a cathode active material, and may contain an anode active material, as the active material. Examples of the cathode active material may include an oxide active material. Examples of the oxide active material may include a rock salt bed type active material such as LiCoO₂, LiMnO₂, LiNiO₂, LiVO₂, and LiNi_{1/3}Co_{1/3}Mn_{1/3}O₂; a spinel type active material such as LiMn₂O₄, Li(Ni_{0.5}Mn_{1.5})O₄; and an olivine type active material such as LiFePO₄, LiMnPO₄, LiNiPO₄, and LiCoPO₄. Meanwhile, examples of the anode active material may include a Li-based active material such as Li and a Li alloy, a carbon active material such as graphite, and a Si-based active material such as Si and SiO.

Each of the first coating layer and the second coating layer may contain a conductive material. Examples of the conductive material may include a carbon material. Examples of the carbon material may include a particulate carbon material such as acetylene black (AB) and Ketjen black (KB), and a fiber carbon material such as carbon fiber, carbon nanotube (CNT), and carbon nanofiber (CNF). Each of the first coating layer and the second coating layer may contain just one kind of the conductive material, and may contain two kinds or more thereof.

Each of the first coating layer and the second coating layer may contain a binder. Examples of the binder may include a cellulose-based binder such as carboxymethylcellulose (CMC), a rubber-based binder such as styrene butadiene rubber (SBR), and a fluorine-based binder such as polyvinylidene fluoride (PVDF). Each of the first coating layer and the second coating layer may contain just one kind of the binder, and may contain two kinds or more thereof.

The electrode member in the present disclosure includes a current collector, and a coating layer arranged on the current collector. The coating layer includes layers in the order of a first coating layer and a second coating layer from the current collector side. A first electrode layer is obtained by drying the first coating layer, and a second electrode layer is obtained by drying the second coating layer. In other words, an electrode body including a current collector, a first electrode layer arranged on the current collector, and a second electrode layer arranged on the first electrode layer, is obtained. The first electrode layer and the second electrode layer may be a cathode layer and may be an anode layer.

Also, the present disclosure can also provide a production device of an electrode body to be used for a battery. The production device of the electrode body includes a backup roll, a first die, a second die, and a dryer configured to dry a first coating layer and a second coating layer. The backup roll, the first die, and the second die are in the same contents as those described above. Also, as the dryer, conventionally known dryer can be used.

The electrode member and the electrode body in the present disclosure are used in a battery. The kind of the battery in the present disclosure is not particularly limited, and examples thereof may include a lithium ion secondary battery. Examples of the applications of the battery may include a power source for vehicles such as hybrid electric vehicles (HEV), plug-in hybrid electric vehicles (PHEV), battery electric vehicles (BEV), gasoline-fueled automobiles and diesel powered automobiles. In some embodiments, the battery may be used as a power source for driving hybrid electric vehicles (HEV), plug-in hybrid electric vehicles (PHEV), or battery electric vehicles (BEV). Also, the battery in the present disclosure may be used as a power source for moving bodies other than vehicles (such as rail road transportation, vessel and airplane), and may be used as a power source for electronic products such as information processing equipment.

B. Production Method of Electrode Member

FIG. 2 is a schematic cross-sectional view exemplifying the production method of an electrode member in the present disclosure. In FIG. 2, first, current collector 1 to be carried is supported by backup roll 10 (supporting step). Next, first coating layer 2 is formed by coating the current collector 1 on the backup roll 10 with a first slurry using first die 20a (first coating layer forming step). Next, second coating layer 3 is formed by coating the first coating layer 2 on the backup roll 10 with a second slurry using second die 20b (second coating layer forming step). Each of the first die 20a and the second die 20b are independent. Also, when horizontal direction is regarded as a reference 0°, perpendicular downward is regarded as +90°, and perpendicular upward is regarded as −90°, a discharge angle of the second slurry in the second die 20b is −90° or more and +60° or less.

According to the present disclosure, when the discharge angle of the second slurry in the second die is the specified angle, an electrode member with which occurrence of production failure is inhibited, is obtained.

1. Supporting Step

The supporting step in the present disclosure is a step of supporting a current collector to be carried, by a backup roll. The backup roll and the current collector are in the same contents as those described in □A. Electrode member□ above. The carrying speed of the current collector is not particularly limited, but for example, it is 0.3 m/minute or more and 3 m/minute or less.

2. First Coating Layer Forming Step

The first coating layer forming step in the present disclosure is a step of forming a first coating layer by coating the current collector on the backup roll with a first slurry using a first die. The first die, the first slurry and the first coating layer are in the same contents as those described in □A. Electrode member□ above. The discharge amount of the first slurry, and the gap between the first die and the backup roll are appropriately adjusted so as to obtain the first coating layer with the desired thickness. Also, the first slurry may be continuously applied, and may be intermittently applied.

3. Second Coating Layer Forming Step

The second coating layer forming step in the present disclosure is a step of forming a second coating layer by coating the first coating layer on the backup roll, with a second slurry using a second die. Also, when horizontal direction is regarded as a reference 0°, perpendicular downward is regarded as +90°, and perpendicular upward is regarded as −90°, a discharge angle of the second slurry in the second die is −90° or more and +60° or less. The second die, the second slurry and the second coating layer are in the same contents as those described in □A. Electrode member□ above. The discharge amount of the second slurry, and the gap between the second die and the backup roll are appropriately adjusted so as to obtain the second coating layer with the desired thickness. Also, the second slurry is usually applied along with the first coating layer.

4. Electrode Member

The electrode member in the present disclosure is in the same contents as those described in □A. Electrode member□ above. Also, the present disclosure can provide a production method of an electrode body including a drying step of drying the first coating layer and the second coating layer in the electrode member to form a first electrode layer from the first coating layer, and to form a second electrode layer from the second coating layer. Thereby, an electrode body including a current collector, and electrode layers (first electrode layer and second electrode layer) arranged on the current collector, is obtained.

The present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Example 1

<Production of First Slurry>

An anode active material (graphite), a first binder (CMC) and a second binder (SBR) were mixed in the ratio shown in Table 1 below. Water was added to the obtained mixture to obtain a first slurry. The obtained first slurry was placed still at 25° C. for 24 hours, and then the shear viscosity in the shear velocity of 1 s⁻¹ was measured using a rheometer.

<Production of Second Slurry>

An anode active material (graphite), a first binder (CMC) and a second binder (SBR) were mixed in the ratio shown in Table 1 below. Water was added to the obtained mixture to obtain a second slurry. The shear viscosity of the obtained second slurry was measured in the same manners as above.

<Production of Electrode Member>

A first coating layer (70 μm) and a second coating layer (370 μm) were formed on a current collector (Cu foil) while carrying the current collector using the production device shown in FIG. 1A, and thereby an electrode member was obtained. The discharge angle θₐ of the first die was 0°, and the discharge angle θ_{b} of the second die was +60°.

TABLE 1

| | | | Shear viscosity | Thickness |
|---|---|---|---|---|
| | CMC | SBR | in shear | of coating |
| | concentration | concentration | velosity of 1/s | layer |
| | [weight %] | [weight %] | [Pa · second] | [μm] |
| First slurry | 0.6 | 9.0 | 7 | 70 |
| Second slurry | 0.4 | 1.2 | 2 | 370 |

### Examples 2 to 4

An electrode member was respectively obtained in the same manner as in Example 1 except that the discharge angle θ_{b} of the second die was changed to +45° in Example 2, +30° in Example 3, and 0° in Example 4. Incidentally, in Example 4, the production device shown in FIG. 4B was used instead of the production device shown in FIG. 1A.

### Comparative Example 1

An electrode member was obtained in the same manner as in Example 1, except that the discharge angle θ_{b} of the second die was changed to +90°.

[Evaluation]

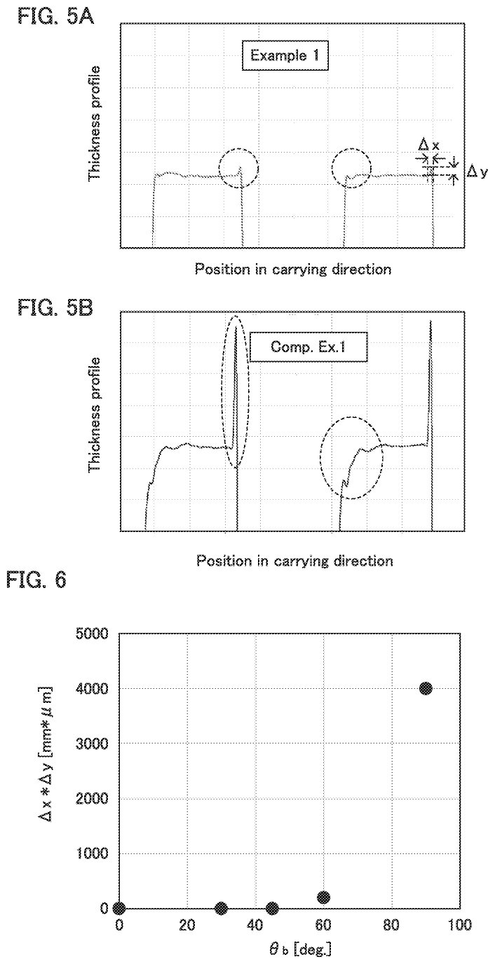

The surfaces of the second coating layers obtained in Example 1 and Comparative Example 1 were measured by a laser displacement sensor to prepare a thickness profile of the second coating layers. The results are shown in FIGS. 5A and 5B. As shown in FIG. 5A, in Example 1, it was confirmed that a protruding part was slightly formed in the end edge of the first time (left side in the drawing), and a defective part was slightly formed in the starting edge of the second time (right side in the drawing). In contrast, in Comparative Example 1, it was confirmed that a large protruding part was formed in the end edge of the first time (left side in the drawing), and a large defective part was formed in the starting edge of the second time (right side in the drawing).

Also, as shown in FIG. 5A, the length of the protruding part in the x axis direction is regarded as Δₓ (mm), and the length of the protruding part in the y axis direction is regarded as Δ_{y} (μm). Here, the product (Δₓ* Δ_{y}) of Δₓ and Δ_{y} is defined as uneven discharge amount. The results of uneven discharge amount in Examples 1 to 4, and Comparative Example 1 are shown in FIG. 6. As shown in FIG. 6, it was 200 [mm*μm] in Example 1, and it was 4000 [mm*μm] in Comparative Example 1. Also, neither the protruding part nor the defective part was confirmed in Examples 2 to 4, and the uneven discharge amount was 0. In this manner, it was confirmed that the occurrence of production failure was inhibited when the discharge angle θ_{b} of the second die was +60° or less.

### REFERENCE SINGS LIST

1 current collector
2 first coating layer
3 second coating layer
10 backup roll
20 die
20a first die
20b second die
100 production device

What is claimed is:

1. A production device of an electrode member to be used for a battery, the production device comprising:
a backup roll configured to support a current collector to be carried;
a first die configured to form a first coating layer by coating the current collector on the backup roll with a first slurry; and
a second die configured to form a second coating layer by coating the first coating layer on the backup roll with a second slurry, wherein
each of the first die and the second die are independent; and
when horizontal direction is regarded as a reference 0°, perpendicular downward is regarded as +90°, and perpendicular upward is regarded as −90°, a discharge angle of the second slurry in the second die is −90° or more and +60° or less.

2. The production device of an electrode member according to claim 1, wherein a discharge angle of the first slurry in the first die is −90° or more and +30° or less.

3. The production device of an electrode member according to claim 1, wherein
the second slurry contains an active material and a binder;
a shear viscosity of the second slurry in a shear velocity of 1 s⁻¹ is 5 Pa·second or less; and
a thickness of the second coating layer is 200 μm or more.

4. The production device of an electrode member according to claim 1, wherein, in a carrying direction of the current collector, the production device includes: a first sensor configured to measure a state of a surface of the first coating layer, in a downstream side of the first die and in an upstream side of the second die; and a second sensor configured to measure a state of a surface of the second coating layer, in a downstream side of the second die.

5. A production method of an electrode member to be used for a battery, the production method comprising:
a supporting step of supporting a current collector to be carried, by a backup roll;
a first coating layer forming step of forming a first coating layer by coating the current collector on the backup roll with a first slurry using a first die; and
a second coating layer forming step of forming a second coating layer by coating the first coating layer on the backup roll with a second slurry using a second die; wherein
each of the first die and the second die are independent; and
when horizontal direction is regarded as 0°, perpendicular downward is regarded as +90°, and perpendicular upward is regarded as −90°, a discharge angle of the second slurry in the second die is −90° or more and +60° or less.
